(19) United States
(12) Patent Application Publication
(10) Pub. No.: US 2026/0005264 A1
(43) Pub. Date: Jan. 1, 2026

(54) ELECTROCHEMICAL DEVICE

(71) Applicants: HYUNDAI MOTOR COMPANY, Seoul (KR); KIA CORPORATION, Seoul (KR)

(72) Inventors: Kwi Seong Jeong, Hwaseong-si (KR); Hyo Kyung Han, Hwaseong-si (KR); Won Seok Yang, Hwaseong-si (KR)

(73) Assignees: HYUNDAI MOTOR COMPANY, Seoul (KR); KIA CORPORATION, Seoul (KR)

(21) Appl. No.: 18/965,243

(22) Filed: Dec. 2, 2024

(30) Foreign Application Priority Data
Jun. 28, 2024 (KR) 10-2024-0085687

(51) Int. Cl. H01M 8/0254; H01M 4/86; H01M 8/0276; H01M 8/1004; H01M 8/2483

(52) U.S. Cl. CPC H01M 8/0254; H01M 4/8605; H01M 8/0276; H01M 8/1004; H01M 8/2483

(57) ABSTRACT

The present disclosure relates to an electrochemical device including a membrane electrode assembly, a first separator including a manifold part through which a reaction fluid is introduced or discharged, a flow path part spaced apart from the manifold part, and a through-hole provided between the manifold part and the flow path part and configured to guide the reaction fluid, which has passed through the manifold part, to the flow path part, a first porous transport layer configured to entirely cover the flow path part and the through-hole and interposed between the membrane electrode assembly and the first separator, and a first protrusion pattern provided on the first separator, and configured to support the first porous transport layer on the first separator while defining a guide flow path configured to guide the reaction fluid, which has passed through the through-hole, to the flow path part.

### CROSS-REFERENCE TO RELATED APPLICATION

This application claims priority to and the benefit of Korean Patent Application No. 10-2024-0085687 filed in the Korean Intellectual Property Office on Jun. 28, 2024, the entire contents of which are incorporated herein by reference.

### TECHNICAL FIELD

The present disclosure relates to an electrochemical device, and more particularly, to an electrochemical device capable of ensuring structural rigidity and improving stability and reliability.

### BACKGROUND ART

There is a consistent increasing need for research and development on alternative energy to cope with global warming and depletion of fossil fuel. Hydrogen energy is attracting attention as a practical solution for solving environmental and energy issues.

In particular, because hydrogen has high energy density and properties suitable for application on a grid-scale, hydrogen is in the limelight as a future energy carrier.

A water electrolysis stack, which is one of electrochemical devices, refers to a device that produces hydrogen and oxygen by electrochemically decomposing water. The water electrolysis stack may be configured by stacking several tens or several hundreds of water electrolysis cells (unit cells) in series.

The water electrolysis cell may include a membrane electrode assembly (MEA), first and second porous transport layers (anode and cathode porous transport layer (PTLs)) respectively disposed at two opposite surfaces of the membrane electrode assembly, and separators (anode and cathode separators).

Meanwhile, because deformation of the membrane electrode assembly may degrade performance and efficiency of the water electrolysis cell and increase differential pressure, the deformation of and damage to the membrane electrode assembly need to be minimized.

However, in the related art, there is a problem that the membrane electrode assembly is deformed and damaged by fastening pressure applied to the water electrolysis cell and pressure (e.g., cathode side pressure) applied to the membrane electrode assembly.

In addition, in the related art, when the membrane electrode assembly is deformed and damaged by the fastening pressure applied to the water electrolysis cell and the pressure applied to the membrane electrode assembly, a through-hole, which guides a reaction fluid, which is introduced through a manifold part, to a reaction region (flow path part) of the separator, is covered by the membrane electrode assembly (in a state in which the membrane electrode assembly is disposed to block the through-hole). For this reason, there is a problem in that the fluidity and flow efficiency of the reaction fluid passing through the through-hole are degraded, and the differential pressure between two opposite ends (an inlet end and an outlet end) of a manifold flow path is increased.

Therefore, recently, various studies have been conducted to ensure a smooth flow of the reaction fluid while minimizing deformation of and damage to the membrane electrode assembly, but the study results are still insufficient. Accordingly, there is a need to develop a technology to ensure the smooth flow of the reaction fluid while minimizing deformation of and damage to the membrane electrode assembly.

### SUMMARY

The present disclosure has been made in an effort to provide an electrochemical device capable of ensuring structural rigidity and improving stability and reliability.

In particular, the present disclosure has been made in an effort to minimize deformation of and damage to a membrane electrode assembly caused by fastening pressure applied to a unit cell and pressure applied to the membrane electrode assembly.

The present disclosure has also been made in an effort to stably ensure a flow path (flow path cross-sectional area) for a reaction fluid while preventing a through-hole from being clogged by deformation of a membrane electrode assembly and a first porous transport layer.

The present disclosure has also been made in an effort to ensure fluidity and flow efficiency of a reaction fluid and minimize an increase in differential pressure.

The present disclosure has also been made in an effort to improve durability and prolong a lifespan.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides an electrochemical device including a membrane electrode assembly (MEA), a first separator including a manifold part through which a reaction fluid is introduced or discharged, a flow path part spaced apart from the manifold part and configured to define a reaction region configured to react with the membrane electrode assembly, and a through-hole provided between the manifold part and the flow path part and configured to guide the reaction fluid, which has passed through the manifold part, to the flow path part, the first separator being stacked on one surface of the membrane electrode assembly, a first porous transport layer configured to entirely cover the flow path part and the through-hole and interposed between the membrane electrode assembly and the first separator, and a first protrusion pattern provided on the first separator, disposed adjacent to the through-hole, and configured to support the first porous transport layer on the first separator while defining a guide flow path configured to guide the reaction fluid, which has passed through the through-hole, to the flow path part.

This is to ensure structural rigidity and improve stability and reliability of the electrochemical device.

There is a problem in the related art that the membrane electrode assembly is easily deformed and damaged by fastening pressure applied to the water electrolysis cell and pressure (e.g., cathode side pressure) applied to the membrane electrode assembly. When the membrane electrode assembly is deformed and damaged by the fastening pressure applied to the water electrolysis cell and the pressure applied to the membrane electrode assembly, a through-hole, which guides a reaction fluid, which is introduced through a manifold part, to a reaction region (flow path part) of the separator, is covered by the membrane electrode assembly (in a state in which the membrane electrode assembly is disposed to block the through-hole). For this reason, there is a problem in that the fluidity and flow efficiency of the reaction fluid passing through the through-hole are degraded, and the differential pressure between two opposite ends (an inlet end and an outlet end) of a manifold flow path is increased.

In contrast, according to the embodiment of the present disclosure, the membrane electrode assembly is supported by the first porous transport layer, and the first porous transport layer is supported by the first protrusion pattern. Therefore, it is possible to obtain an advantageous effect of minimizing deformation of and damage to the membrane electrode assembly caused by the fastening pressure applied to the water electrolysis cell and the pressure applied to the membrane electrode assembly.

Moreover, according to the embodiment of the present disclosure, the membrane electrode assembly and the first porous transport layer, which correspond to the through-hole, are supported by the first protrusion pattern, such that the through-hole may be prevented from being clogged by deformation of the membrane electrode assembly and the first porous transport layer. Therefore, it is possible to obtain an advantageous effect of stably ensuring the flow path (the flow path cross-sectional area) for the reaction fluid, ensuring the fluidity and flow efficiency of the reaction fluid, and minimizing an increase in differential pressure.

The first protrusion pattern may have various structures capable of supporting the first porous transport layer on the first separator while defining the guide flow path.

According to the exemplary embodiment of the present disclosure, the first protrusion pattern may include a first-first protrusion protruding from one surface of the first separator that faces the first porous transport layer, and a first-second protrusion protruding from one surface of the first separator and spaced apart from the first-first protrusion in a width direction of the first separator, and the guide flow path may be defined between the first-first protrusion and the first-second protrusion.

According to the exemplary embodiment of the present disclosure, the first porous transport layer may be in close contact with the membrane electrode assembly in a state in which the first porous transport layer is supported by the first-first protrusion and the first-second protrusion and spaced apart from the through-hole.

According to the exemplary embodiment of the present disclosure, the first-first protrusion and the first-second protrusion may be formed in relief on one surface of the first separator by partially processing a part of the first separator.

As described above, in the embodiment of the present disclosure, the first-first protrusion and the first-second protrusion may be formed together at the time of forming the first separator (e.g., during the process of forming the flow path). Therefore, it is possible to obtain an advantageous effect of simplifying the structure and manufacturing process and reducing the costs.

According to the exemplary embodiment of the present disclosure, the electrochemical device may include a second protrusion pattern provided on the first separator, disposed adjacent to the through-hole, and configured to define a movement flow path configured to guide the reaction fluid, which has passed through the manifold part, to the through-hole, the second protrusion pattern and the first protrusion pattern being configured to collectively support the first porous transport layer on the first separator.

The second protrusion pattern may have various structures capable of supporting the first porous transport layer on the first separator while defining the movement flow path.

According to the exemplary embodiment of the present disclosure, the second protrusion pattern may include a second-first protrusion formed in relief on one surface of the first separator, which faces the first porous transport layer, by partially processing a part of the first separator, and a second-second protrusion spaced apart from the second-first protrusion in a width direction of the first separator and formed in relief on one surface of the first separator, and the movement flow path may be defined along an internal space of the second-first protrusion and an internal space of the second-second protrusion.

According to the exemplary embodiment of the present disclosure, the first porous transport layer may be in close contact with the membrane electrode assembly in a state in which the first porous transport layer is supported by the second-first protrusion and the second-second protrusion and spaced apart from the through-hole.

According to the exemplary embodiment of the present disclosure, the second protrusion pattern and the first protrusion pattern may be disposed on different lines in a longitudinal direction of the first separator.

As described above, according to the embodiment of the present disclosure, the second protrusion pattern and the first protrusion pattern are disposed on different lines in the longitudinal direction of the first separator, such that the first protrusion pattern and the second protrusion pattern may be disposed alternately in the width direction of the first separator and support the first porous transport layer. Therefore, it is possible to obtain an advantageous effect of more stably maintaining the arrangement state of the first porous transport layer and more effectively suppressing deformation of and damage to the first porous transport layer.

According to the exemplary embodiment of the present disclosure, the first porous transport layer may be provided to have relatively higher rigidity than the membrane electrode assembly.

As described above, in the embodiment of the present disclosure, the first porous transport layer, which has relatively higher rigidity than the membrane electrode assembly, is sized to entirely cover not only the flow path part but also the through-holes. Therefore, it is possible to obtain an advantageous effect of minimizing deformation of and damage to the membrane electrode assembly caused by fastening pressure applied to the unit cell and pressure applied to the membrane electrode assembly.

According to the exemplary embodiment of the present disclosure, the electrochemical device may include a sealing member provided on one surface of the first separator, which faces the membrane electrode assembly, and configured to seal a portion between the membrane electrode assembly and the first separator.

The sealing member may have various structures capable of sealing the portion between the membrane electrode assembly and the first separator.

According to the exemplary embodiment of the present disclosure, the sealing member may include a first sealing portion configured to surround a periphery of the first porous transport layer, and a second sealing portion connected to the first sealing portion and configured to support one surface of the first porous transport layer that faces the first separator.

According to the exemplary embodiment of the present disclosure, the second sealing portion may be defined to have a thickness corresponding to the first protrusion pattern.

Because the second sealing portion has a thickness corresponding to the first protrusion pattern as described above, it is possible to obtain an advantageous effect of minimizing a degree to which the first porous transport layer is separated and pressed by the second sealing portion even though the second sealing portion is disposed to overlap the first porous transport layer.

### BRIEF DESCRIPTION OF THE DRAWINGS

FIG. 1 is a view of an electrochemical device according to an embodiment of the present disclosure.

FIG. 2 is a view of a first separator of the electrochemical device according to the embodiment of the present disclosure.

FIG. 3 is a view of a manifold part and a flow path part of the electrochemical device according to the embodiment of the present disclosure.

FIG. 4 is a view for explaining a movement route for a reaction fluid passing through the first separator in the electrochemical device according to the embodiment of the present disclosure.

FIG. 4A is an exploded view of a portion of the electromechanical device of FIG. 4 according to the embodiment of the present disclosure.

FIGS. 5 and 6 are views of a sealing member of the electrochemical device according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

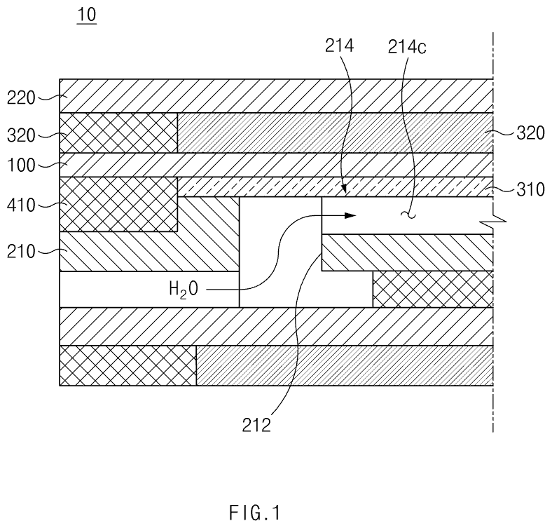

With reference to FIGS. 1 to 6, an electrochemical device 10 includes a membrane electrode assembly (MEA) 100. The electrochemical device 10 also includes a first separator 210 including a manifold part MZ through which a reaction fluid is introduced or discharged, a flow path part RZ spaced apart from the manifold part MZ and configured to define a reaction region configured to react with the membrane electrode assembly 100, and through-holes 212 provided between the manifold part MZ and the flow path part RZ and configured to guide the reaction fluid, which has passed through the manifold part MZ, to the flow path part RZ, the first separator 210 being stacked on one surface of the membrane electrode assembly 100. The electrochemical device 10 further includes a first porous transport layer 310 configured to entirely cover the flow path part RZ and the through-holes 212 and interposed between the membrane electrode assembly 100 and the first separator 210. The electrochemical device 10 also includes a first protrusion pattern 214 provided on the first separator 210, disposed adjacent to the through-holes 212, and configured to support the first porous transport layer 310 on the first separator 210, the first protrusion pattern 214 being configured to define guide flow paths 214c configured to guide the reaction fluid, which has passed through the through-holes 212, to the flow path part RZ.

In the embodiment of the present disclosure, the electrochemical device 10 is defined as including both a steam electrolysis stack configured to produce hydrogen and oxygen by electrochemically decomposing water and a fuel cell stack configured to generate electrical energy through a chemical reaction of fuel (e.g., hydrogen).

Hereinafter, an example will be described in which the electrochemical device according to the embodiment of the present disclosure is used as the steam electrolysis stack that produces hydrogen and oxygen by decomposing water through an electrochemical reaction.

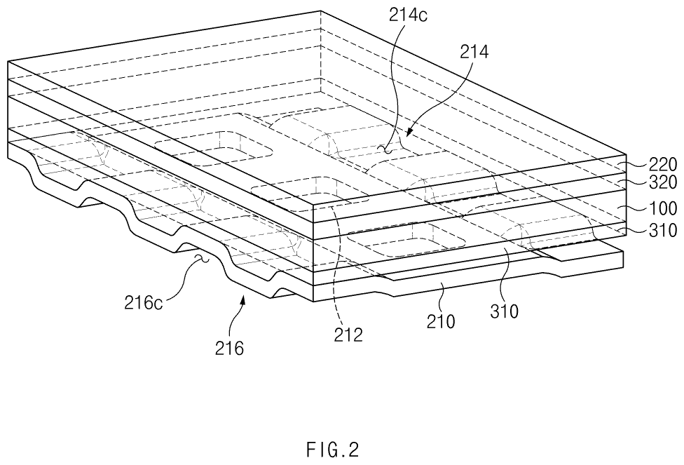

With reference to FIGS. 1 and 2, the water electrolysis stack (electrochemical device) may be configured by stacking several tens or several hundreds of unit cells (water electrolysis cells) in a reference stacking direction (e.g., an upward/downward direction based on FIG. 1).

More specifically, the unit cell may include a reaction layer (not illustrated) and the separators (the first and second separators 210 and 220) respectively stacked on one surface and the other surface of the reaction layer. The water electrolysis stack may be configured by stacking the plurality of unit cells in the reference stacking direction and then assembling endplates (not illustrated) to the two opposite ends of the plurality of unit cells.

The reaction layer may have various structures capable of generating the electrochemical reaction of the reaction fluid (e.g., water). The present disclosure is not restricted or limited by the type and structure of the reaction layer.

For example, the reaction layer may include the membrane electrode assembly (MEA) 100, the first porous transport layer 310 being in close contact with one surface (a bottom surface based on FIG. 1) of the membrane electrode assembly 100, and a second porous transport layer 320 being in close contact with the other surface (a top surface based on FIG. 1) of the membrane electrode assembly 100.

The membrane electrode assembly 100 may be changed in structure and material in accordance with required conditions and design specifications, and the present disclosure is not limited or restricted by the structure and material of the membrane electrode assembly 100.

For example, the membrane electrode assembly 100 may include a solid oxide cell, and porous current collecting layers provided to be in close contact with two opposite surfaces of the solid oxide cell.

The solid oxide cell may be variously changed in structure and material in accordance with required conditions and design specifications. The present disclosure is not restricted or limited by the structure and material of the solid oxide cell.

For example, a solid oxide cell assembly may be configured by attaching catalyst electrode layers (e.g., an anode layer and a cathode layer), in which electrochemical reactions are generated, to two opposite surfaces of an electrolyte layer (e.g., yttria-stabilized zirconia (YSZ)).

For reference, water supplied to a fuel electrode layer (anode), which is a reduction electrode for the steam electrolysis, is separated into hydrogen, electrons, and oxygen ions. Then, the oxygen ions move to an air electrode layer (cathode), which is an oxidation electrode, through an electrolyte membrane, and the electrons move through an external circuit. In addition, the hydrogen gas may be discharged to a fuel electrode outlet. The oxygen ions may be converted into oxygen gas in an air electrode, and the oxygen gas may be discharged to an air electrode outlet.

With reference to FIGS. 1, 2, 3, 4, and 4A, the separators 210 and 220, together with the reaction layer, constitute a single unit cell (water electrolysis cell). The separators 210 and 220 serve to block hydrogen and water separated by the reaction layer and ensure flow paths (flow fields) through which hydrogen and water flow.

In addition, the separators 210 and 220 may also serve to distribute heat, which is generated from the unit cell, to the entire unit cell, and the excessively generated heat may be discharged to the outside by the fluid flowing along the separators 210 and 220.

For reference, in the embodiment of the present disclosure, the separators 210 and 220 are defined as including both a cathode separator and an anode separator that independently define the flow paths (channels) for water (or water and oxygen) and the flow paths (channels) for hydrogen in the water electrolysis stack.

For example, the first separator 210 (anode separator), which faces one surface of the membrane electrode assembly 100, may define a flow path (channel) for water (or water and hydrogen). The second separator 220 (cathode separator), which faces the other surface of the membrane electrode assembly 100, may define a flow path (channel) for oxygen.

More specifically, the first separator 210 includes the manifold part MZ through which the reaction fluid is introduced or discharged, the flow path part RZ spaced apart from the manifold part MZ and configured to define the reaction region configured to react with the membrane electrode assembly 100, and the through-holes 212 provided between the manifold part MZ and the flow path part RZ and configured to guide the reaction fluid, which has passed through the manifold part MZ, to the flow path part RZ.

The first separator 210 may have various structures and be made of various materials in accordance with required conditions and design specifications. The present disclosure is not restricted or limited by the structure and material of the first separator 210.

For example, the first separator 210 may be provided in the form of an approximately quadrangular plate and made of a typical metallic material (e.g., stainless, Inconel, or aluminum). According to another embodiment of the present disclosure, the first separator may be made of another material such as graphite or a carbon composite.

The flow path part RZ is disposed at an approximately central portion of the first separator 210 and faces one surface of the membrane electrode assembly 100 to define the reaction region.

The flow path part RZ may include a plurality of flow paths (channels, not illustrated) disposed to be spaced apart from one another. The present disclosure is not restricted or limited by the number of flow paths and the arrangement structure of the flow paths.

The manifold parts MZ (e.g., water manifolds or oxygen manifolds) are penetratively provided at two opposite ends of the separator based on a longitudinal direction D2 with the flow path part RZ interposed therebetween, and the manifold parts MZ serve to move (supply and discharge) hydrogen, water, and oxygen, respectively.

The manifold part MZ may be variously changed in number and arrangement interval in accordance with required conditions and design specifications. The present disclosure is not restricted or limited by the number of manifold parts MZ and the arrangement intervals between the manifold parts MZ.

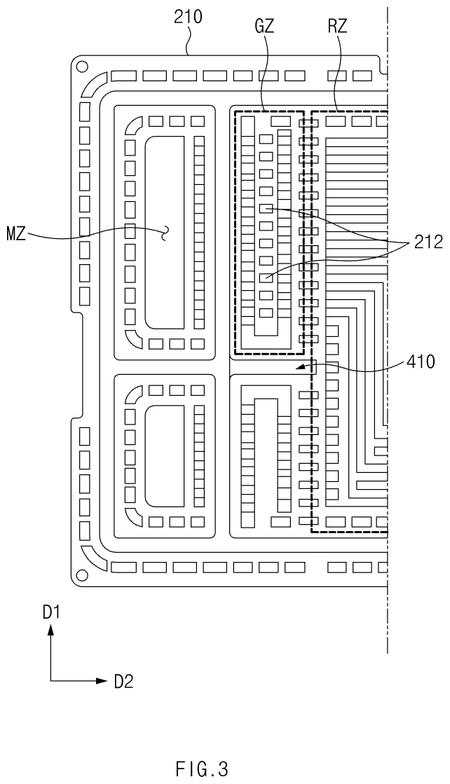

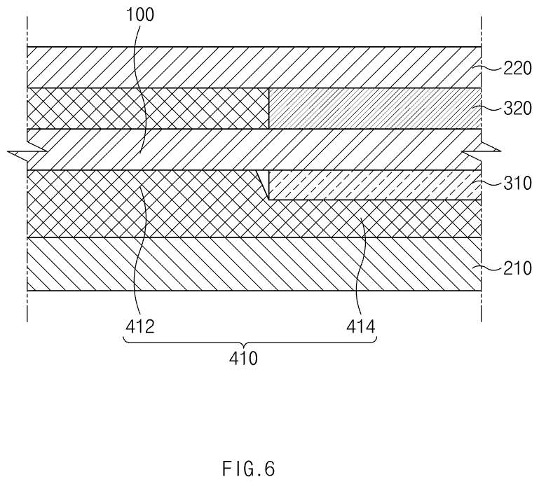

For example, with reference to FIGS. 3 and 5, the two manifold parts MZ may be provided at one end (a left end) of the first separator 210 (or the second separator), and the two manifold parts MZ may be provided at the other end (a right end) of the first separator 210 (or the second separator).

The manifold part MZ may be variously changed in structure and shape in accordance with required conditions and design specifications. The present disclosure is not restricted or limited by the structure and shape of the manifold part MZ.

For example, the manifold part MZ may be provided to have an approximately quadrangular shape. According to another embodiment of the present disclosure, the manifold part may have a circular or other shapes.

The through-hole 212 is configured to guide the reaction fluid, which has passed through the manifold part MZ, to the flow path part RZ. More specifically, the through-hole 212 is formed through the first separator 210 so as to be positioned in a reaction fluid guide part GZ defined between the manifold part MZ and the flow path part RZ.

The through-hole 212 may have various structures capable of guiding the reaction fluid, which has passed through the manifold part MZ, to the flow path part RZ. The present disclosure is not restricted or limited by the structure and shape of the through-hole 212.

For example, the plurality of through-holes 212 each having an approximately quadrangular shape may be provided between the manifold part MZ and the flow path part RZ and spaced apart from one another in a width direction D1 of the first separator 210. Alternatively, the through-hole 212 may have a circular or other shapes.

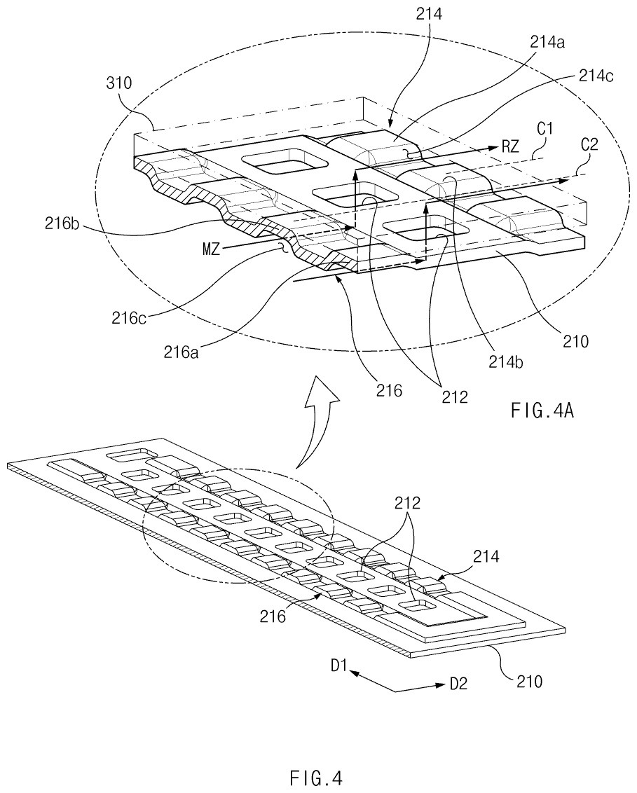

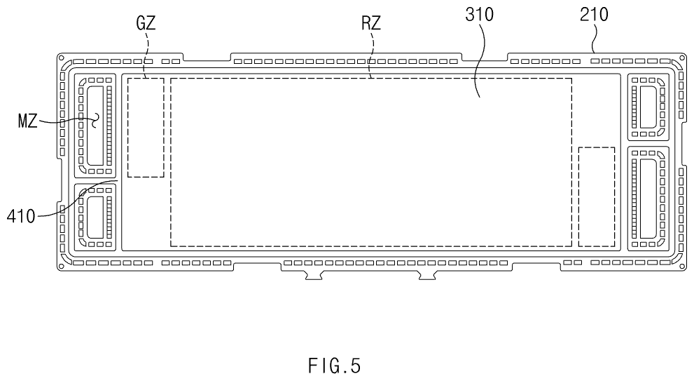

With the above-mentioned structure, the reaction fluid (e.g., water) supplied to the manifold part MZ may be supplied to the through-holes 212 along movement flow paths 216c defined in one surface (e.g., a bottom surface based on FIG. 4) of the first separator 210. The reaction fluid having passed through the through-holes 212 may be supplied to the flow path part RZ along the guide flow paths 214c defined in the other surface (e.g., a top surface based on FIG. 4) of the first separator 210.

The first porous transport layer 310 and the second porous transport layer 320 are configured to uniformly distribute the reaction fluid.

More specifically, the first porous transport layer 310 is interposed between the membrane electrode assembly 100 and the first separator 210, and the second porous transport layer 320 is interposed between the membrane electrode assembly 100 and the second separator 220.

The first porous transport layer 310 and the second porous transport layer 320 may have various structures capable of diffusing the reaction fluid. For example, the first porous transport layer 310 and the second porous transport layer 320 may each have a porous structure made of metal fibers or powder materials having pores with predetermined sizes.

The first porous transport layer 310 and the second porous transport layer 320 may be variously changed in pore sizes and materials in accordance with required conditions and design specifications. The present disclosure is not restricted or limited by the pore sizes and materials of the first porous transport layer 310 and the second porous transport layer 320.

In particular, the first porous transport layer 310 and the second porous transport layer 320 may each be sized to entirely cover the flow path part RZ and the through-holes 212. Hereinafter, an example will be described in which the first porous transport layer 310 and the second porous transport layer 320 have approximately quadrangular shapes that entirely cover the region between the manifold parts MZ provided at two opposite ends of the separator.

More particularly, the first porous transport layer 310 may be provided to have relatively higher rigidity than the membrane electrode assembly 100.

As described above, in the embodiment of the present disclosure, the first porous transport layer 310, which has relatively higher rigidity than the membrane electrode assembly 100, is sized to entirely cover not only the flow path part RZ but also the through-holes 212. Therefore, it is possible to obtain an advantageous effect of minimizing deformation of and damage to the membrane electrode assembly 100 caused by fastening pressure applied to the unit cell and pressure applied to the membrane electrode assembly 100.

The first protrusion pattern 214 is provided on the first separator 210. The first protrusion pattern 214 serves to support the first porous transport layer 310 on the first separator 210 while defining the guide flow paths 214c configured to guide the reaction fluid, which has passed through the through-holes 212, to the flow path part RZ. More specifically, the first protrusion pattern 214 is provided on the reaction fluid guide part GZ defined between the manifold part MZ and the flow path part RZ.

This is based on the fact that the membrane electrode assembly 100 and the first porous transport layer 310 are deformed and clog the through-holes 212 when the fastening pressure applied to the unit cell and the pressure applied to the membrane electrode assembly 100 increase to predetermined degrees or higher even though the first porous transport layer 310, which has higher rigidity than the membrane electrode assembly 100, supports the membrane electrode assembly 100.

In contrast, in the embodiment of the present disclosure, the first protrusion pattern 214 is provided on one surface of the first separator 210 that faces the first porous transport layer 310, the guide flow paths 214c for moving the reaction fluid is ensured by means of the first protrusion pattern 214, and the first porous transport layer 310 is supported without being deformed. Therefore, it is possible to obtain an advantageous effect of minimizing deformation of and damage to the membrane electrode assembly 100 and the first porous transport layer 310 while ensuring the fluidity and flow efficiency of the reaction fluid.

The first protrusion pattern 214 may have various structures capable of supporting the first porous transport layer 310 on the first separator 210 while defining the guide flow path 214c. The present disclosure is not restricted or limited by the structure and shape of the first protrusion pattern 214.

Hereinafter, an example will be described in which the first protrusion pattern 214 is provided between the through-holes 212 and the flow path part RZ. According to another embodiment of the present disclosure, the first protrusion pattern may be provided above or below the through-holes (above or below the through-holes based on the width direction of the first separator).

According to the exemplary embodiment of the present disclosure, the first protrusion pattern 214 may include first-first protrusions 214a protruding from one surface of the first separator 210 that faces the first porous transport layer 310, and first-second protrusions 214b protruding from one surface of the first separator 210 and spaced apart from the first-first protrusion 214a in the width direction of the first separator 210. The guide flow path 214c may be defined between the first-first protrusion 214a and the first-second protrusion 214b.

The first-first protrusions 214a and the first-second protrusions 214b may be provided alternately in the width direction D1 of the first separator 210. The number of first-first protrusions 214a, the number of first-second protrusions 214b, and a spacing interval between the first-first protrusion 214a and the first-second protrusion 214b may be variously changed in accordance with required conditions and design specifications.

In particular, the first-first protrusions 214a (or first-second protrusion 214b) may be disposed alternately in the width direction D1 of the first separator 210 to define a continuous waveform cross-section together with the guide flow path 214c.

The first-first protrusion 214a and the first-second protrusion 214b may have various structures in accordance with required conditions and design specifications. The present disclosure is not restricted or limited by the structures and shapes of the first-first protrusion 214a and the first-second protrusion 214b.

For example, the first-first protrusion 214a and the first-second protrusion 214b may each be provided in the form of a quadrangular block having a quadrangular cross-section. According to another embodiment of the present disclosure, the first-first protrusion and the first-second protrusion may each have an approximately truncated conical shape (circular truncated cone shape) having a circular cross-section that gradually decreases from one end (one end adjacent to the first separator) toward the other end. Alternatively, the first-first protrusion and the first-second protrusion may each have other shapes or a truncated pyramidal shape (a shape of a frustum of a pyramid) having a polygonal cross-section that gradually decreases from one end (one end adjacent to the first separator) toward the other end.

In particular, the first porous transport layer 310 may be in close contact with the membrane electrode assembly 100 in a state in which the first porous transport layer 310 is supported by the first-first protrusion 214a and the first-second protrusion 214b and spaced apart from the through-holes 212.

The first-first protrusion 214a and the first-second protrusion 214b may be provided in various ways in accordance with required conditions and design specifications.

According to the exemplary embodiment of the present disclosure, the first-first protrusion 214a and the first-second protrusion 214b may be provided in relief on one surface of the first separator 210 by partially processing (e.g., press-processing) a part of the first separator 210.

In particular, the first-first protrusion 214a and the first-second protrusion 214b may be formed together with the flow path (through a single process) when the flow path (channel) is formed by partially processing a part of the first separator 210.

As described above, in the embodiment of the present disclosure, the first-first protrusion 214a and the first-second protrusion 214b may be formed together at the time of forming the first separator 210 (e.g., during the process of forming the flow path). Therefore, it is possible to obtain an advantageous effect of simplifying the structure and manufacturing process and reducing the costs.

According to the exemplary embodiment of the present disclosure, the electrochemical device 10 may include a second protrusion pattern 216 provided on the first separator 210, disposed adjacent to the through-holes 212, and configured to define the movement flow paths 216c configured to guide the reaction fluid, which has passed through the manifold part MZ, to the through-hole 212. The second protrusion pattern 216 and the first protrusion pattern 214 collectively support the first porous transport layer 310 on the first separator 210.

The second protrusion pattern 216 may have various structures capable of supporting the first porous transport layer 310 on the first separator 210 while defining the movement flow paths 216c. The present disclosure is not restricted or limited by the structure and shape of the second protrusion pattern 216.

Hereinafter, an example will be described in which the second protrusion pattern 216 is provided between the manifold part MZ and the through-holes 212. According to another embodiment of the present disclosure, the second protrusion pattern may be provided above or below the through-holes (above or below the through-holes based on the width direction of the first separator).

According to the exemplary embodiment of the present disclosure, the second protrusion pattern 216 may include second-first protrusions 216a formed in relief on one surface of the first separator 210, which faces the first porous transport layer 310, by partially processing a part of the first separator 210, and second-second protrusions 216b formed in relief on one surface of the first separator 210 and spaced apart from the second-first protrusion 216a in the width direction of the first separator 210. The movement flow path 216c may be defined along an internal space of the second-first protrusion 216a and an internal space of the second-second protrusion 216b.

The second-first protrusions 216a and the second-second protrusions 216b may be provided alternately in the width direction D1 of the first separator 210. The number of second-first protrusions 216a, the number of second-second protrusions 216b, and a spacing interval between the second-first protrusion 216a and the second-second protrusion 216b may be variously changed in accordance with required conditions and design specifications.

The second-first protrusion 216a and the second-second protrusion 216b may have various structures in accordance with required conditions and design specifications. The present disclosure is not restricted or limited by the structures and shapes of the second-first protrusion 216a and the second-second protrusion 216b.

For example, the second-first protrusion 216a and the second-second protrusion 216b may each be provided in the form of a quadrangular block having a quadrangular cross-section. According to another embodiment of the present disclosure, the second-first protrusion and the second-second protrusion may each have an approximately truncated conical shape (circular truncated cone shape) having a circular cross-section that gradually decreases from one end (one end adjacent to the first separator) toward the other end. Alternatively, the second-first protrusion and the second-second protrusion may each have other shapes or a truncated pyramidal shape (a shape of a frustum of a pyramid) having a polygonal cross-section that gradually decreases from one end (one end adjacent to the first separator) toward the other end.

In particular, the first porous transport layer 310 may be in close contact with the membrane electrode assembly 100 in a state in which the first porous transport layer 310 is supported by the second-first protrusion 216a and the second-second protrusion 216b and spaced apart from the through-holes 212.

According to the exemplary embodiment of the present disclosure, the second-first protrusion 216a and the second-second protrusion 216b may be provided in relief on one surface of the first separator 210 by partially processing (e.g., press-processing) a part of the first separator 210.

In particular, the second-first protrusion 216a and the second-second protrusion 216b may be formed together with the flow path (through a single process) when the flow path (channel) is formed by partially processing a part of the first separator 210.

As described above, in the embodiment of the present disclosure, the second-first protrusion 216a and the second-second protrusion 216b may be formed together at the time of forming the first separator 210 (e.g., during the process of forming the flow path). Therefore, it is possible to obtain an advantageous effect of simplifying the structure and manufacturing process and reducing the costs.

With reference to FIGS. 4 and 4A, according to the exemplary embodiment of the present disclosure, the second protrusion pattern 216 and the first protrusion pattern 214 may be disposed on different lines in the longitudinal direction D2 of the first separator 210.

For example, the first-first protrusion 214a (or the first-second protrusion) may be disposed in the longitudinal direction D2 of the first separator 210 based on a first line C1, and the second-first protrusion 216a (or the second-second protrusion) may be disposed in the longitudinal direction D2 of the first separator 210 based on a second line C2 spaced apart from the first line C1.

As described above, the first-first protrusions 214a (or the first-second protrusions) and the second-first protrusions 216a (or the second-second protrusions) are disposed alternately in the width direction D1 of the first separator 210 and support the first porous transport layer 310. Therefore, it is possible to obtain an advantageous effect of more stably maintaining the arrangement state of the first porous transport layer 310 and more effectively suppressing deformation of and damage to the first porous transport layer 310.

In the embodiment of the present disclosure illustrated and described above, the example has been described in which the second protrusion pattern 216 and the first protrusion pattern 214 are disposed on different lines in the longitudinal direction of the first separator 210. However, according to another embodiment of the present disclosure, the second protrusion pattern and the first protrusion pattern may be disposed on the same line in the longitudinal direction of the first separator 210.

With reference to FIGS. 1, 5, and 6, according to the exemplary embodiment of the present disclosure, the electrochemical device 10 may include a sealing member 410 provided on one surface of the first separator 210, which faces the membrane electrode assembly 100, and configured to seal a portion between the membrane electrode assembly 100 and the first separator 210.

The sealing member 410 is configured to seal the portion between the membrane electrode assembly 100 and the first separator 210. The flow path part RZ and the manifold part MZ may be sealed independently of each other by means of the sealing member 410.

In this case, the configuration in which the portion between the membrane electrode assembly 100 and the first separator 210 is sealed may be defined as a configuration in which a gap between the membrane electrode assembly 100 and the first separator 210 is sealed.

Because the portion between the membrane electrode assembly 100 and the first separator 210 is sealed by the sealing member 410 as described above, it is possible to obtain an advantageous effect of maintaining the sealability of the first separator 210 and preventing the reaction fluid, which is introduced along the manifold part MZ, and the reaction fluid, which flows along the flow path part RZ, from being mixed together through the gap between the membrane electrode assembly 100 and the first separator 210.

The sealing member 410 may be manufactured in various ways in accordance with required conditions and design specifications, and the present disclosure is not restricted or limited by the method of manufacturing the sealing member 410.

For example, the sealing member 410 may be manufactured by applying or transferring a sealant made of an elastic material such as rubber, silicone, or urethane onto the surface of the first separator 210 or performing a printing process on the surface of the first separator 210 with the sealant.

According to another embodiment of the present disclosure, the sealing member may be attached to the first separator by injection molding. Alternatively, the sealing member may be manufactured (by injection molding, for example) separately from the first separator and then attached (bonded) to the first separator.

The sealing member 410 may have various structures capable of sealing the portion between the membrane electrode assembly 100 and the first separator 210. The present disclosure is not restricted or limited by the structure of the sealing member 410.

According to the exemplary embodiment of the present disclosure, the sealing member 410 may include a first sealing portion 412 configured to surround a periphery of the first porous transport layer 310, and a second sealing portion 414 connected to the first sealing portion 412 and configured to support one surface of the first porous transport layer 310 that faces the first separator 210.

For example, the first sealing portion 412 may be provided in the form of an approximately quadrangular ring configured to surround the periphery of the first porous transport layer 310, and the second sealing portion 414 may have an approximately straight shape and be integrally connected to an inner surface portion of the first sealing portion 412.

For example, the first sealing portion 412 may be defined to have a thickness corresponding to a sum of a thickness of the first porous transport layer 310 and a thickness of the first protrusion pattern 214.

In particular, the second sealing portion 414 may have a smaller thickness than the first sealing portion 412.

According to the exemplary embodiment of the present disclosure, the second sealing portion 414 may be defined to have a thickness corresponding to the first protrusion pattern 214.

In this case, the configuration in which the second sealing portion 414 has a thickness corresponding to the first protrusion pattern 214 may be understood as a configuration in which the second sealing portion 414 is smaller in thickness than the first sealing portion 412 by a thickness of the first porous transport layer 310.

Because the second sealing portion 414 has a thickness corresponding to the first protrusion pattern 214 as described above, it is possible to obtain an advantageous effect of minimizing a degree to which the first porous transport layer 310 is separated and pressed by the second sealing portion 414 even though the second sealing portion 414 is disposed to overlap the first porous transport layer 310.

According to the embodiment of the present disclosure described above, it is possible to obtain an advantageous effect of ensuring the structural rigidity and improving the stability and reliability.

In particular, according to the embodiment of the present disclosure, it is possible to obtain an advantageous effect of minimizing deformation of and damage to the membrane electrode assembly caused by the fastening pressure applied to the unit cell and the pressure applied to the membrane electrode assembly.

In addition, according to the embodiment of the present disclosure, it is possible to obtain an advantageous effect of stably ensuring the flow path (the flow path cross-sectional area) for the reaction fluid while preventing the through-hole from being clogged by deformation of the membrane electrode assembly and the first porous transport layer.

In addition, according to the embodiment of the present disclosure, it is possible to obtain an advantageous effect of ensuring the fluidity and flow efficiency of the reaction fluid and minimizing an increase in differential pressure.

In addition, according to the embodiment of the present disclosure, it is possible to obtain an advantageous effect of improving the durability and prolonging the lifespan.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. An electrochemical device comprising:
a membrane electrode assembly (MEA);
a first separator comprising a manifold part through which a reaction fluid is introduced or discharged, a flow path part spaced apart from the manifold part and configured to define a reaction region configured to react with the membrane electrode assembly, and a through-hole provided between the manifold part and the flow path part and configured to guide the reaction fluid, which has passed through the manifold part, to the flow path part, the first separator being stacked on one surface of the membrane electrode assembly;
a first porous transport layer configured to entirely cover the flow path part and the through-hole and interposed between the membrane electrode assembly and the first separator; and
a first protrusion pattern provided on the first separator, disposed adjacent to the through-hole, and configured to support the first porous transport layer on the first separator while defining a guide flow path configured to guide the reaction fluid, which has passed through the through-hole, to the flow path part.

2. The electrochemical device of claim 1, wherein the first protrusion pattern comprises
a first-first protrusion protruding from one surface of the first separator that faces the first porous transport layer, and
a first-second protrusion protruding from one surface of the first separator and spaced apart from the first-first protrusion in a width direction of the first separator, and
wherein the guide flow path is defined between the first-first protrusion and the first-second protrusion.

3. The electrochemical device of claim 2, wherein the first porous transport layer is supported by the first-first protrusion and the first-second protrusion and spaced apart from the through-hole.

4. The electrochemical device of claim 2, wherein the first-first protrusion and the first-second protrusion are formed in relief on one surface of the first separator by partially processing a part of the first separator.

5. The electrochemical device of claim 1, comprising
a second protrusion pattern provided on the first separator, disposed adjacent to the through-hole, and configured to define a movement flow path configured to guide the reaction fluid, which has passed through the manifold part, to the through-hole, the second protrusion pattern and the first protrusion pattern being configured to collectively support the first porous transport layer on the first separator.

6. The electrochemical device of claim 5, wherein the second protrusion pattern comprises
a second-first protrusion formed in relief on one surface of the first separator, which faces the first porous transport layer, by partially processing a part of the first separator, and
a second-second protrusion spaced apart from the second-first protrusion in a width direction of the first separator and formed in relief on one surface of the first separator, and
wherein the movement flow path is defined along an internal space of the second-first protrusion and an internal space of the second-second protrusion.

7. The electrochemical device of claim 6, wherein the first porous transport layer is supported by the second-first protrusion and the second-second protrusion and spaced apart from the through-hole.

8. The electrochemical device of claim 5, wherein the second protrusion pattern and the first protrusion pattern are disposed on different lines in a longitudinal direction of the first separator.

9. The electrochemical device of claim 1, wherein the first porous transport layer is provided to have higher rigidity than the membrane electrode assembly.

10. The electrochemical device of claim 1, comprising
a sealing member provided on one surface of the first separator, which faces the membrane electrode assembly, and configured to seal a portion between the membrane electrode assembly and the first separator.

11. The electrochemical device of claim 10, wherein the sealing member comprises
a first sealing portion configured to surround a periphery of the first porous transport layer, and
a second sealing portion connected to the first sealing portion and configured to support one surface of the first porous transport layer that faces the first separator.

12. The electrochemical device of claim 11, wherein the second sealing portion is defined to have a thickness corresponding to the first protrusion pattern.

13. The electrochemical device of claim 1, comprising
a second separator stacked on another surface of the membrane electrode assembly, and
a second porous transport layer interposed between the membrane electrode assembly and the second separator.

14. The electrochemical device of claim 13, wherein the second porous transport layer is provided to have a size corresponding to the first porous transport layer.
